(19) United States
(12) Patent Application Publication
(10) Pub. No.: US 2014/0074559 A1
(43) Pub. Date: Mar. 13, 2014

(54) COST EFFECTIVE SYSTEM AND METHOD TO COLLECT AND ANALYSE PLANT & INFRASTRUCTURE MONITORING INFORMATION WITHOUT COMPROMISING ON THE AMOUNT OF INFORMATION COLLECTED OR ITS QUALITY

(71) Applicant: Kalycito Infotech Private Limited, Coimbatore (IN)

(72) Inventor: Bhagath Singh Karunakaran, Coimbatore (IN)

(73) Assignee: Kalycito Infotech Private Limited, Coimbatore (IN)

(21) Appl. No.: 14/033,424

(22) Filed: Sep. 20, 2013

(30) Foreign Application Priority Data
Sep. 12, 2012 (IN) 3942/CHE/2012

(51) Int. Cl. G06Q 10/06

(52) U.S. Cl. CPC G06Q 10/0637
USPC 705/7.36

(57) ABSTRACT

A system for collecting and analyzing monitoring information includes one or more hardware collection units, one or more centralized logging and monitoring units and one or more display unit. The one or more hardware collection units collect raw data related to the at least one industrial or infrastructure parameter from one or more sources. The one or more hardware collection units timestamp the collected raw data. The one or more centralized logging and monitoring units receive the timestamped raw data from the one or more hardware collection units through a communication network. The one or more centralized logging and monitoring units calibrate and consolidate the timestamped raw data to obtain a calibrated data and store the calibrated data in at least one format. The display unit is configured to display a user interface to contextualize and analyze the calibrated data.

### BACKGROUND

1. Technical Field

The embodiments herein generally relate to a data collection and monitoring system, and more particularly, to a system and method for collecting and analyzing various industrial and infrastructural parameters from different sources that are geographically distributed to optimize costs and to reduce carbon footprint.

2. Description of the Related Art

In an industrial and infrastructural environment, it is increasingly necessary to monitor various parameters such as energy consumed by different equipments, utilization of equipments, utilization of man power, wastages in material at finer level to optimize costs and reduce carbon foot print. Typically, each vendor supplying components to an industrial or infrastructural environment (say a machine vendor or an air conditioner vendor), uses a sensor system to sense and collect various parameters pertaining to their component. When many such vendor components are brought together, it creates several islands of intelligent information, making it hard for use in decision making process (for e.g. unplanned machine downtime and operation or air-conditioner running wastefully when the room is unoccupied). Also each vendor uses a different method to provide access to his information resulting in a non-homogenous way to access or compare information from different systems.

Apart from this, most of the systems in the market for monitoring industrial or infrastructural parameters are primarily designed for control, which inflates the cost of the monitoring equipment. There are also some systems in the market that are designed only for monitoring, but they are either standalone, highly customized to a requirement or work over a rudimentary network limiting scalability possibilities.

Accordingly, there remains a need for a homogenous way to access or compare aforementioned parameters at finer level. Such homogenous system, capable of seamlessly comparing various parameters affecting cost for an individual user, can also help in economic growth and carbon reduction at macroeconomic level, if the cost of such system encourages widespread deployment.

### SUMMARY

In view of a foregoing, an embodiment herein provides a system for collecting and analyzing monitoring information of at least one industrial or infrastructure parameter is provided. The system includes one or more hardware collection units, one or more centralized logging and monitoring units and one or more display unit. The one or more hardware collection units are configured to collect raw data related to the at least one industrial or infrastructure parameter from one or more sources. The one or more hardware collection units timestamp the collected raw data. The raw data comprises values associated with the at least one industrial or infrastructure parameter collected at predefined periodic time intervals. The one or more centralized logging and monitoring units are configured to receive the timestamped raw data from the one or more hardware collection units through a communication network. The one or more centralized logging and monitoring units calibrate and consolidate the timestamped raw data to obtain a calibrated data and store the calibrated data in at least one format. The display unit is configured to display a user interface to contextualize and analyze the calibrated data.

The one or more centralized logging and monitoring units may include (i) a data collection engine that is configured to store the calibrated data in at least one storage unit in (a) the at least one format, and (b) at least one time resolution for easy, fast and fail-safe retrieval of data; (ii) a user interface engine that is configured to store at least one application program for providing the user interface; (iii) a data contextualization engine that is configured to contextualize the calibrated data related to the at least one industrial or infrastructure parameter at the time of data retrieval based on a user input; and (iv) a data analysis and interpretation engine that is configured to analysis and interpret the at least one industrial or infrastructure parameter corresponding to the user input received through the user interface.

The one or more hardware collection units may include at least one sensor, or at least one chip, or combinations thereof. The display unit may include a user interface to configure calibration information required for calibrating the time-stamped raw data. The display unit may further include a user interface to configure (a) analysis and interpretation information required for analysing and interpreting the calibrated data, (b) contextualization information required for contextualizing the calibrated data, and (c) dispatching information required for dispatching an interpretation

In one embodiment, a method for collecting raw data includes values that relate to one or more parameters from one or more sources using at least one hardware collection unit and analyzing and interpreting the values using at least one centralized logging and monitoring platform (CLMP) is provided. The at least one CLMP may include a computing device. The method includes the following steps: (i) obtaining, by the at least one hardware collection unit, at least one value related to the one or more parameters from the one or more sources, the one or more parameters are at least one of (a) industrial parameters, and (b) infrastructure parameters; (ii) time-stamping, by the at least one hardware collection unit, the at least one value to obtain time-stamped value, the time-stamped value comprise a time at which a value associated with the one or more parameters is measured; and (iii) communicating the time-stamped value to the at least one centralized logging and monitoring platform (CLMP); (iv) calibrating, by the computing device, the time-stamped value to obtain calibrated data; (v) storing the calibrated data on at least one storage unit in (a) at least one format, and (b) at least one time resolution; (vi) contextualizing, by a processor of the computing device, the calibrated data based on at least one input includes a selection of at least one of: (i) a desired parameter, (ii) a desired duration, and (iii) a desired duration associated with a desired parameter; (vii) generating, by the processor of the computing device, an interpretation based on the input, the interpretation comprises at least one of (a) status of at least one of (i) the desired parameter, (ii) the desired duration, and (iii) the desired duration associated with the desired parameter, and (b) an analysis of at least one of (i) the desired parameter, (ii) the desired duration, and (iii) the desired duration associated with the desired parameter; and (viii) displaying, at a display unit, the user interface.

The method may further include (i) consolidating and de-normalizing the calibrated data for easy, fast and fail-safe retrieval of data; and (ii) storing the consolidated and de-normalized data form in the at least format on at least one storage unit. The method may further include providing a user interface to configure calibration information required for calibrating the time-stamped raw data. The one or more hardware collection units may include at least one sensor, or at least one chip, or combinations thereof.

In another embodiment, a method for analyzing data includes values that relate to one or more parameters collected from one or more sources using a centralized logging and monitoring platform (CLMP) is provided. The CLMP may include a computing device. The method includes the following steps: (i) obtaining, by the computing device, at least one time-stamped value that relate to the one or more parameters collected at predefined periodic intervals, the one or more parameters are at least one of (a) industrial parameters, and (b) infrastructure parameters, the time-stamped value comprise a time at which a value associated with the one or more parameters is measured; (ii) calibrating, by the computing device, the at least one time-stamped value to obtain calibrated data; (iii) storing the calibrated data on at least one storage unit in (a) at least one format, and (b) at least one time resolution; (iv) contextualizing, by a processor of the computing device, the calibrated data based on at least one input includes a selection of at least one of: (a) a desired parameter, (b) a desired duration, and (c) a desired duration associated with a desired parameter; and (v) generating, by the processor of the computing device, an interpretation based on the input, the interpretation comprises at least one of (a) status of at least one of (i) the desired parameter, (ii) the desired duration, and (iii) the desired duration associated with the desired parameter, and (b) an analysis of at least one of (i) the desired parameter, (ii) the desired duration, and (iii) the desired duration associated with the desired parameter.

The method may further include (i) consolidating and de-normalizing the calibrated data for easy, fast and fail-safe retrieval of data; and (ii) storing the consolidated and de-normalized data form in the at least format on at least one storage unit. The method may further include providing a user interface to configure (a) calibration information required for calibrating the time-stamped raw data, (b) analysis and interpretation information required for analysing and interpreting the calibrated data, (c) contextualization information required for contextualizing the calibrated data, and (d) dispatching information required for dispatching an interpretation. The at least one time-stamped value may obtained using one or more hardware collection units. The one or more hardware collection units may include at least one sensor, or at least one chip, or combinations thereof.

### BRIEF DESCRIPTION OF THE DRAWINGS

The embodiments herein will be better understood from the following detailed description with reference to the drawings, in which:

FIG. 1 illustrates a functional top level architecture of a consolidated system for collecting, storing and monitoring parameters simultaneously according to an embodiment herein;

FIG. 2 illustrates the Hardware Collection Unit (HCU) of FIG. 1 interfacing with a sensor and the Centralized Logging and Monitoring Platform (CLMP) of FIG. 1 according to an embodiment herein;

FIGS. 3A and 3B illustrate various connection topologies between the HCU and the CLMP of FIG. 1 according to an embodiment herein;

FIG. 3C illustrates the HCU and the CLMP of FIG. 1 in connection with a generic closed loop feedback control system that can be semi-automated/fully automated and homogenous/heterogeneous according to an embodiment herein;

FIG. 4 is a flow diagram illustrating how a monitoring operation is performed when an analog sensor is interfaced with the HCU of the system of FIG. 1 according to an embodiment herein;

FIG. 5 is a flow diagram illustrating how a monitoring operation is performed when a digital sensor is interfaced with the HCU of the system of FIG. 1 according to an embodiment herein;

FIG. 6 is a table view illustrating raw data that are measured using one or more hardware collection units (HCU) of the system of FIG. 1 from various sources at various intervals of time according to one embodiment of the present disclosure;

FIG. 7, with reference to FIG. 6, is a table view illustrating sources and parameters correspond to values that are obtained using one or more hardware collection units of the system of FIG. 1 according to one embodiment of the present disclosure;

FIG. 8A is a table view illustrating storing calibrated data in various time resolutions according to one embodiment of the present disclosure;

FIG. 8B is a user interface view illustrating providing inputs including a selection of one or more parameters and a time interval associated with an analysis of the one or more parameters, and generating a graphical representation based on the inputs according to one embodiment of the present disclosure; and

FIG. 9 is a flow diagram illustrating a method for collecting calibrating, contextualizing, analyzing, interpreting and dispatching data that correspond to industrial and/or infrastructural parameters according to one embodiment of the present disclosure.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

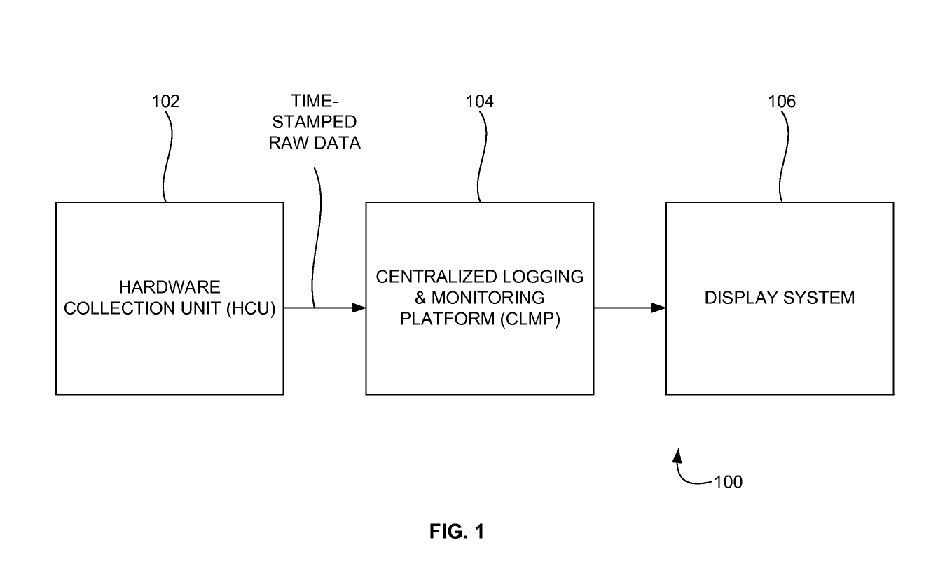

As mentioned, there remains a need for a system and method for collecting and analyzing various industrial parameters without compromising the amount of information collected or its quality. The embodiment herein is achieved by providing a system that includes one or more Hardware Collection Unit (HCU), one or more Centralized Logging and Monitoring Platform (CLMP) and a display system. The one or more HCU collects raw data from the different sensors (e.g., one or more sensors) and timestamps the raw data to obtain time-stamped raw data. The time-stamped raw data is transferred to the one or more CLMP via multiple communication networks. The one or more CLMP receives the time-stamped raw data from the one or more HCU and performs a calibration operation on the time-stamped raw data to obtain a calibrated data. The calibrated data is consolidated and de-normalized and stored in at least one storage unit in at least on time resolution for easy, fast and fail-safe retrieval. The display system provides a user interface to contextualize and analyze the calibrated data. Referring now to FIGS. 1 through 9, where similar reference characters denote corresponding features consistently throughout the figures, preferred embodiments are described herein.

FIG. 1 illustrates a functional top level architecture of a consolidated system 100 for collecting, storing and monitoring parameters simultaneously according to an embodiment herein. The system 100 includes a Hardware Collection Unit (HCU) 102, a Centralized Logging and Monitoring Platform (CLMP) 104 and a display system 106. The HCU 102 is a hardware entity which is capable of interfacing with different types of sensors (e.g., an analog, a digital, etc.) to collect information about one or more parameters (e.g., a temperature, a pressure, a power consumption, ON/OFF, etc.) and variations in the parameters, from one or more sources (e.g., a location, a machine, a plant, an industry, etc.). In one embodiment, the system 100 may includes more than one HCU 102. The HCU 102 collects raw data from the different sensors (e.g., one or more sensors) and timestamps the raw data to obtain time-stamped raw data. The raw data includes values associated with the one or more parameters (e.g., various industrial or infrastructure parameters such as a temperature, a pressure, a power consumption, ON/OFF, etc.) collected at predefined periodic time intervals. In one embodiment, the HCU 102 may include one or more chips (e.g., one or more hardware processors, or one or more microcontrollers), or the one or more sensors, or combination thereof. In one example embodiment, the HCU 102 may be implemented as a SoC (System on Chip), or an IP Core on a FPGA. In another embodiment, the HCU 102 does not contextualize the raw data that is collected from the different sensors, and thus reduces power consumption, minimizes programming/management complexity and minimizes memory/storage requirement such as non-volatile storage memory and RAM. In another embodiment, the HCU 102 does not necessarily store, process, or calibrate the time-stamped raw data. The time-stamped raw data may be transferred to the CLMP 104 via multiple communication networks (e.g., a Local LAN, an Internet, a GPRS/SMS). In another embodiment, the HCU 102 transmits the time-stamped raw data to the CLMP 104 at predefined periodic intervals as configured by the user. The time-stamped raw data includes a time at which a data associated with various industrial or infrastructure parameters is measured. The CLMP 104 may include a data collection engine, a user interface engine, a data contextualization engine, a data analysis and interpretation engine, and at least one storage unit. In one embodiment, the CLMP 104 may include a computing device. In another embodiment, the system 100 may includes more than one CLMP 104.

The data collection engine in the CLMP 104 receives the time-stamped raw data from the HCU 102 and performs a calibration operation on the time-stamped raw data in the data collection engine to obtain a calibrated data. In one embodiment, the calibrated data is consolidated, de-normalized and stored in at least on time resolution (e.g., time based cubes, for minute, hour, day, etc.), and in at least one format (e.g., an OS file system format, a database file format, etc.) at CLMP 104 at the time of reception, and this enables easy, fast and fail-safe retrieval of data. The calibration operation is performed using calibration information stored in the CLMP 104 and the user can configure or modify the calibration information through the display system 106. In one embodiment, the display system 106 provides a user interface to contextualize and analyze the calibrated data. In another embodiment, the display system 106 provides a user interface to configure or modify the calibration information and contextualization information used to calibrate and contextualize the time-stamped raw data. Eliminating calibration and contextualization complexity from the HCU 102 and moving it to the CLMP 104 reduces the cost at the HCU 102 (i.e. reducing initial cost, programming costs and maintenance cost of the HCU 102, etc.) The data collection engine may store the consolidated data in (a) at least on time resolution (e.g., time based cubes for minute, hour, etc.), and (b) at least one format (e.g., an OS file system format, database file format, etc.) on one or more storage units (e.g., two hard disks, etc.). The de-normalization of data is done at a data collection time and not during information retrieval. This enables easy, fast and fail-safe retrieval of data. The schema of data handling at the CLMP 104 can be used for reliable storage and retrieval using low cost PC hardware instead of complex automation hardware or server grade computers, thus to reducing cost at the CLMP 104.

The user interface engine in the CLMP 104 stores at least one application program for providing the user interface. The data analysis and interpretation engine may act as a back-end platform for the user interface engine. The data analysis and interpretation engine retrieves the calibrated data related to various industrial or infrastructure parameters from the one or more storage units. The data contextualization engine contextualizes the calibrated data at the time of data retrieval. The data analysis and interpretation engine provides an analysis and interpretation of at least one industrial or infrastructure parameter corresponding to a user input received through the user interface. The display system 106 displays the user interface which is used to contextualize and analyze the calibrated and consolidated data from the one or more storage units. In one embodiment, the system 100 may include more than one display systems 106. The display system 106 may dispatch the analysis and interpretation information to a user through the user interface. In one embodiment, the user interface allows seamless navigation from one time window to another (previous time, next time, slider, etc) as well one time resolution to another time resolution (e.g., minute, day, month, etc). The CLMP 104 acts as a web server to publish the monitoring information, in one example embodiment. In another embodiment, a standard hardware platform is used to reduce the cost at the CLMP 104.

In general, industrial data can be interpreted to monitor an industrial process based on one or more the following approaches, namely (i) time based, which is based on an amount of time needed to process a desired output, (ii) man based, which is based on an amount of man power needed for a desired output, (iii) material based, which is based on an amount of material quality or quantity for the desired output, (iv) energy based, which is based on an amount of energy directly and indirectly needed to achieve a desired output and (v) capital intensive equipment/infrastructure based, which is based on the utilization of the capital intensive equipment/infrastructure for obtaining the desired output. In one embodiment, the CLMP 104 de-normalizes and stores data based on above five ways. For instance, the time-stamped raw data may be processed in the CLMP 104 and stored in various resolutions for time (e.g., seconds, minutes, hours, shifts, days, weeks, months, quarters and years). The various resolutions of time allow the user to retrieve data in an easy and fast manner to interpret the parameters. Similarly, the time-stamped raw data is processed in the CLMP 104 and stored in various resolutions (e.g., formats) for an operator, a material/process, energy and a machine. In one embodiment, in time based report, the user interface allows the user to move between different time, to subdivide a time window or to aggregate multiple windows.

The display system 106 includes a user interface which allows the user to configure/modify calibration information required for a calibration operation (e.g., a process of converting the raw data into a calibrated data). In one embodiment, the display system 106 includes a user interface which allows the user to configure/modify (a) contextualization information required for a contextualization of the calibrated data, (b) an analysis and interpretation information required for an analysis and interpretation of the calibrated, and/or (c) dispatching information required for dispatching an interpretation (e.g., a graphical interpretation, etc.). The user interface is completely user configurable using mouse clicks and minimal use of keyboard and needs no programming skills. Conventional systems need programming skills to perform equivalent tasks, while in CLMP 104 anyone who knows to handle spreadsheets can configure the system. In typical configurations, the analog values are stored along with “min”, “max” and “average” values, digital inputs are stored along with “ON Time”, “OFF Time” and “Count”. In general the system also records “Time during which NO Data was collected due to network or the HCU 102 related challenges”.

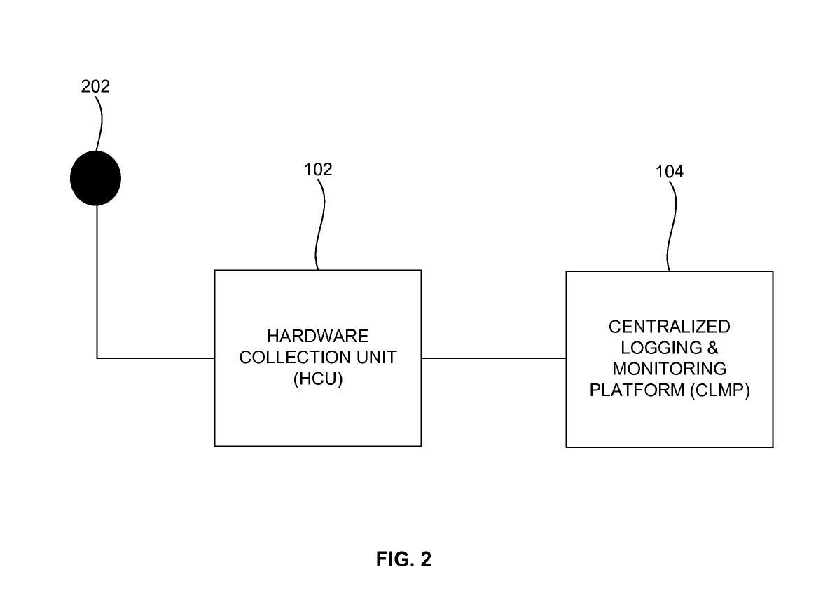

FIG. 2 illustrates the HCU 102 of FIG. 1 interfacing with a sensor 202 and the CLMP 104 according to an embodiment herein. In one example embodiment, the HCU 102 may interfacing with a chip instead of the sensor 202. The sensor 202 ideally is a device that operates to convert a basic physical phenomenon to an electrical signal (e.g., 4 to 20 mA or −10 to 10V) and provide it as a digital or analog input. The sensor 202 can be any kind of sensor, but not limited to, an analog sensor, or a digital sensor. The HCU 102 collects raw data from the sensor 202 and timestamps the raw data to obtain a time-stamped raw data. The HCU 102 acquires it's time information using a standard protocol (e.g., Network Time Protocol (NTP), Precision Time Protocol (PTP)/GPS Clock, etc.) from the CLMP 104, or a centralized time keeping system. The HCU 102 transmits an un-calibrated and time-stamped raw data to the CLMP 104 at a user predefined periodic interval. The CLMP 104 performs a calibration operation on the received time-stamped raw data from the HCU 102. In one embodiment, the complexity is reduced at the HCU 102 by performing the calibration operation in the CLMP 104. Since the calibration operation is performed in the CLMP 104, the HCU 102 does not require memory to store calibration and contextualization information, thus reducing the cost significantly. This also reduces power requirement for HCU 102, that is interfaced with the sensor 202, greatly further enhancing the possibility of wide spread deployment. In one embodiment, the HCU 102 may also interface with a chip or another system instead of the sensor 202 (e.g., a smart sensor with RS232, RS485 or a Modbus interface), even in such a case, the HCU 102 does not require any programming to operate/collect raw data.

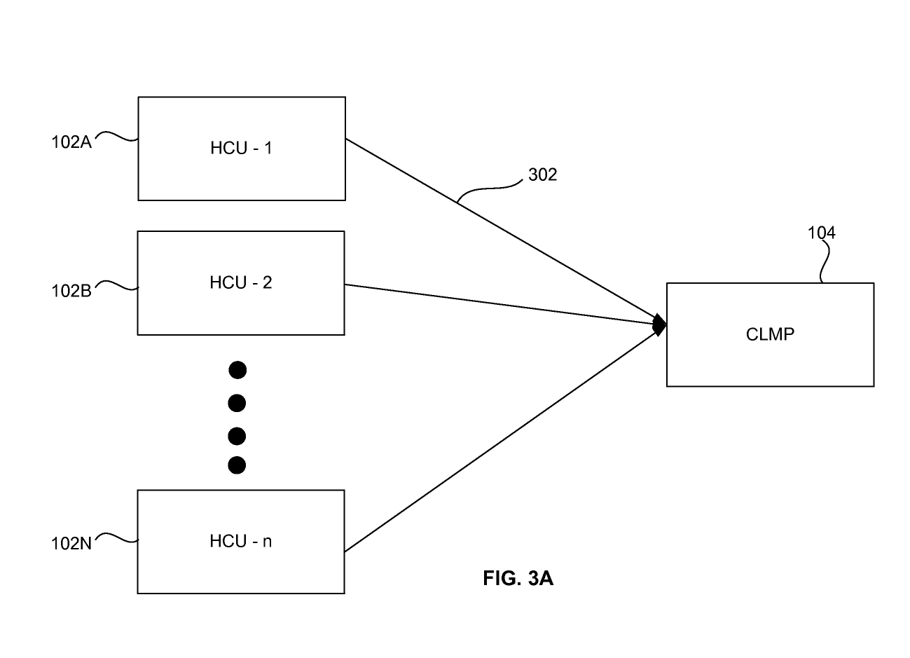

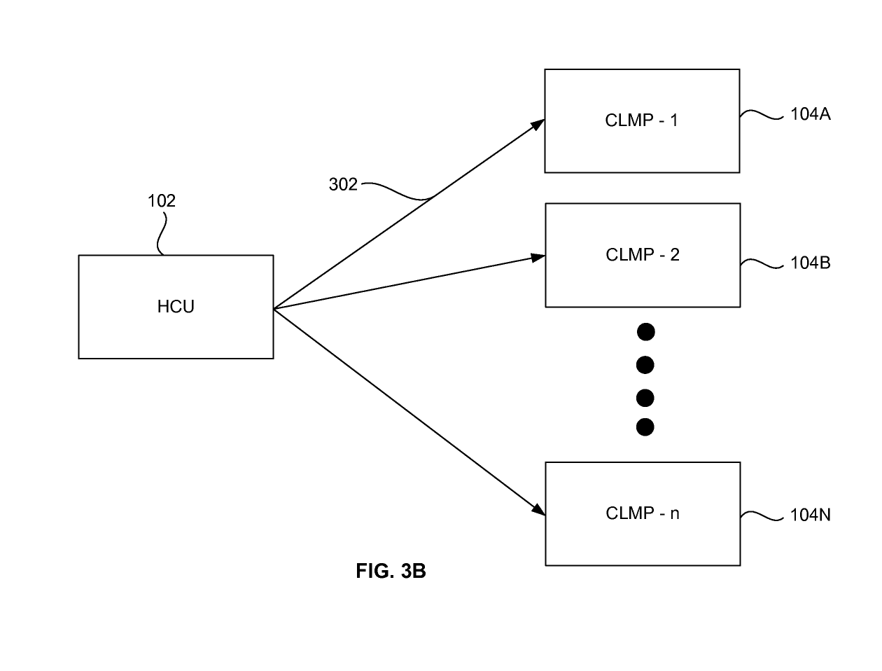

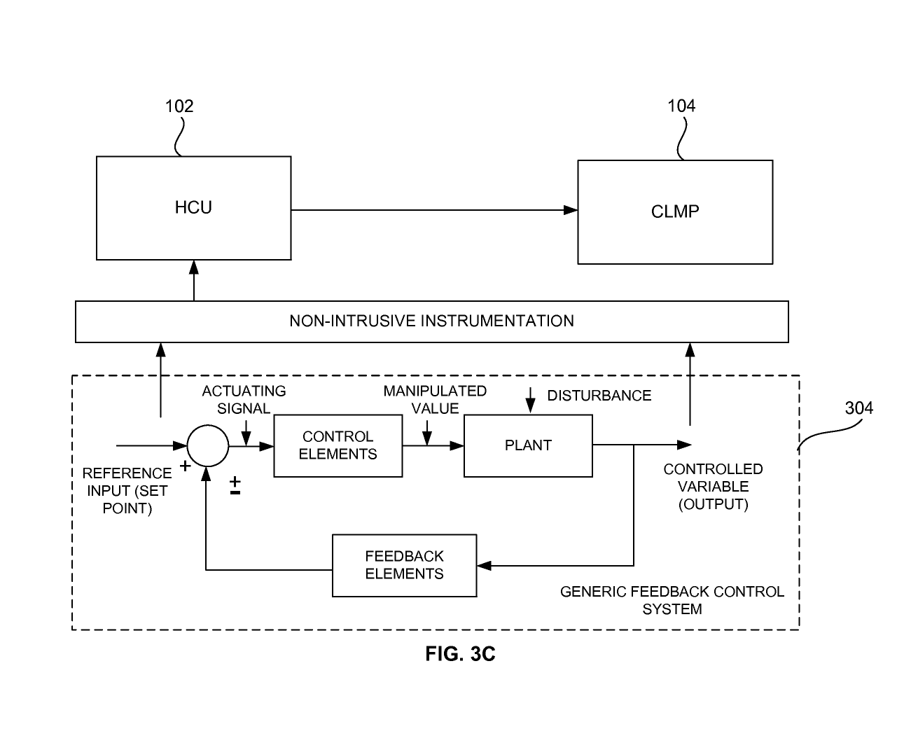

FIGS. 3A and 3B illustrate connection topologies between the HCU 102 and the CLMP 104 of FIG. 1 according to an embodiment herein. A top level architecture of the system in the FIG. 1 is scalable and flexible, so the number of HCU 102 and number of CLMP 104 may be extended or reduced based on requirements. Similarly, a connection between the HCU 102 and the CLMP 104 can be established via a communication link 302. FIG. 3A shows a multiple of HCUs (102A, 102B . . . 102N) that are connected to the CLMP 104 via the communication link 302 using different wired and/or wireless communication technologies such as a GSM, an internet, a GPRS, a Zigbee and a Bluetooth. The HCU 102 non-intrusively collects the data from the one or more sources and transmits to the CLMP 104 via the communication link 302 (e.g., a Local LAN, an Internet, GPRS/SMS).

FIG. 3B illustrates a HCU 102 of FIG. 1 connected to multiple CLMPs (104A, 104B . . . 104N) according to an embodiment herein. Since, the architecture of the system of FIG. 1 is scalable, a single HCU 102 may be connected to multiple CLMPs (104A, 104B . . . 104N). The HCU 102 collects data from sensors and transfers the data to the multiple CLMPs (104A, 104B . . . 104N) in parallel via the communication link 302. This achieves a fail-safe operation of the system, since if one CLMP is down then another CLMP will receive data from the HCU 102 and store it. In one embodiment, multiple HCUs (102-1. 102-2 . . . 102-n) are connected to multiple CLMPs (104A, 104B . . . 104N). Each CLMP receives data from multiple HCUs via the communication link 302 resulting in better reliability by enabling standard 2-out-of-3 (2oo3) or 2-over-2 (2oo2) decision making. In general, devices similar to the CLMP 104 require a server-grade machine or complex automation hardware for storing data. This architecture eliminates the use of the server-grade machine or complex automation hardware.

FIG. 3C illustrates the HCU 102 and the CLMP 104 of FIG. 1 in connection with a manual heterogeneous environment 304 according to an embodiment herein. Typically, the manual heterogeneous environment 304 includes equipments from different manufactures and multiple operators. The operator will control the process based on information displayed via the integrated control panels provided by the respective manufacturer. However, most of these equipments don't share data to the other devices. In one embodiment, simple sensors are attached to the input and outputs stages of the equipment to extract data from heterogeneous environments in a non-intrusive manner by the HCU 102. The HCU 102 then transfers the sensed information to the CLMP 104 in a predefined periodic interval after time stamping the sensed information. Hence, using low cost methods, data is collected from heterogeneous/homogenous and manual/fully automated environments.

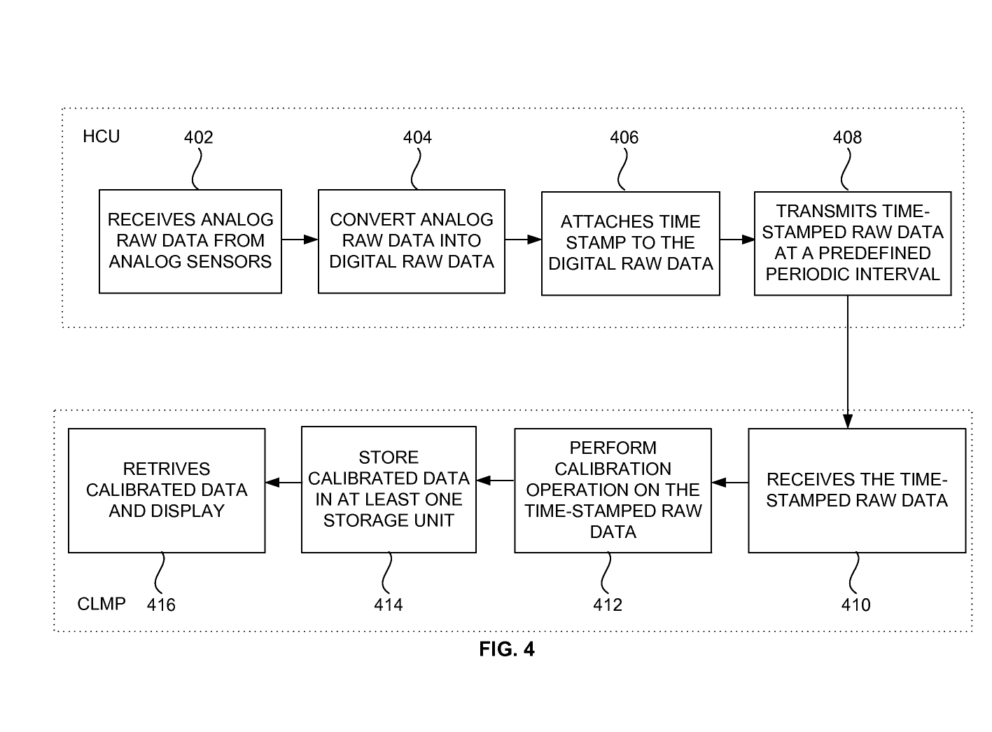

FIG. 4 is a flow diagram illustrating how a monitoring operation is performed when an analog sensor is interfaced with the HCU 102 of the system of FIG. 1 according to an embodiment herein. In step 402, the HCU 102 scans and receives analog raw data from multiple analog sensors. In step 404, the received analog raw data is converted into digital raw data using Digital to Analog Converter (DAC). In step 406, the HCU 102 time-stamps the digital raw data to obtain time-stamped raw data. In step 408, the HCU 102 transmits the time-stamped raw data to the CLMP 104 at a user predefined periodic interval. In step 410, the CLMP 104 receives the time-stamped raw data and retrieves calibration information stored in the CLMP 104. In step 412, the CLMP performs calibration operation on the time-stamped raw data to obtain a calibrated data. In step 414, the calibrated data is stored in one or more storage units in at least one format. In step 416, the calibrated data is retrieved and displayed in the user interface of the display system 106.

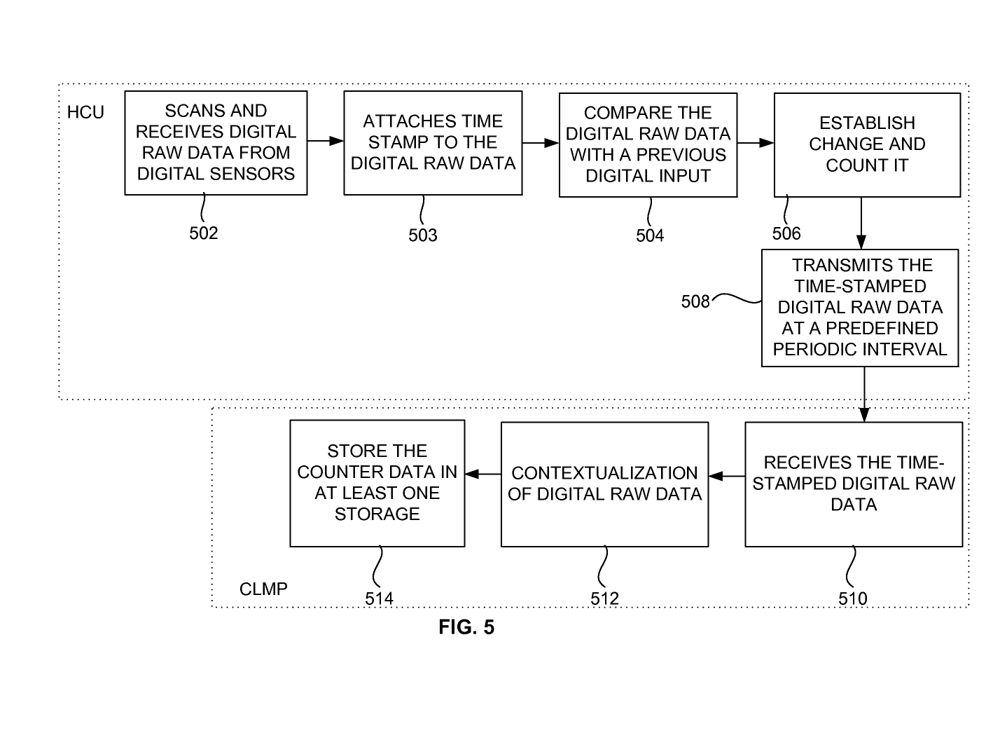

FIG. 5 is a flow diagram illustrating how an operation is performed when a digital sensor is interfaced with the HCU 102 of the system of FIG. 1 according to an embodiment herein. In step 502, the HCU 102 scans and receives digital input (e.g. digital raw data) from the digital sensors at a predefined periodic interval. In step 503, the received digital raw data is time-stamped to obtain time-stamped digital raw data. In step 504, the received digital raw data is compared with a previously scanned digital raw data to establish the change and count it, in step 506. In step 508, the time-stamped digital raw data is transmitted to the CLMP 104 at a predefined periodic time interval. In step 510, the time-stamped digital raw data is received in the CLMP 104. In step 512, contextualization of the digital raw data happens and the following information is extracted: (a) current status of the digital raw data, (b) change state with respect to previous state, (c) number of state changes (counts), (d) time for which the state was ON/high, and (e) time for which the state was OFF/low. In step 514, the counter data is stored in one or more storage units of the CLMP 104 in at least one format (e.g., OS file system format, database file format, etc.).

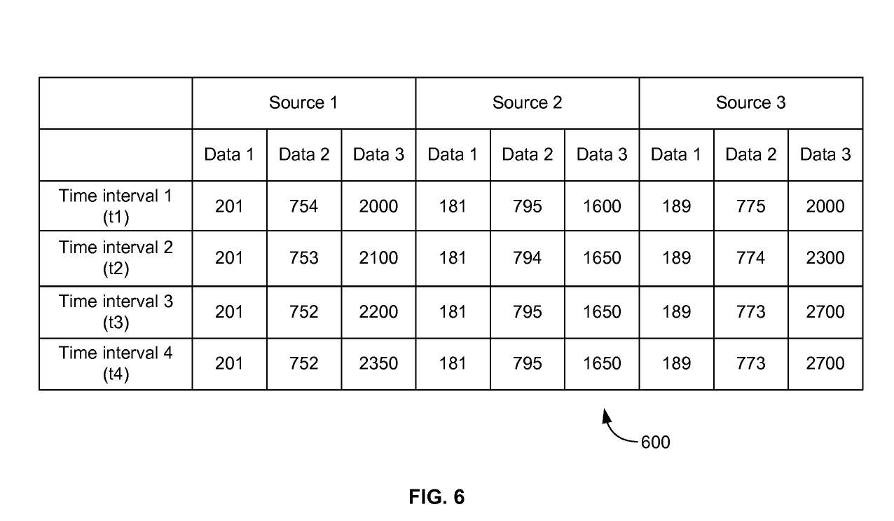

FIG. 6 is a table view 600 illustrating raw data that are measured using one or more hardware collection units (HCU) 102 of the system of FIG. 1 from various sources at various periodic intervals of time according to one embodiment of the present disclosure. For example, values (i.e. data) in the table view 600 associated with monitoring various parameters (e.g., inside temperature, outside temperature, energy consumption, etc.) of various sources (e.g., cold storage units) collected at various periodic intervals of time. For instance, the first hardware collection unit 102 measures/obtains values associated with one or more parameters (e.g., inside temperature, outside temperature, energy consumption, etc.) of a first cold storage unit at a first time interval (t1). Data 1 from source 1 (e.g., the first cold storage unit) represents values of a first parameter (e.g., inside temperature) associated with the first cold storage unit at the first time interval (t1). Similarly, the values of the first parameter are obtained at various periodic intervals of time (e.g., t2, t3, and t4, say 9.00 PM, 10.00 PM, 11.00 PM and 12.00 PM, or 9:00:00 0100 ms, 9:00:00 0200 ms, 9:00:00 0300 ms and 9:00:00 0400 ms, etc). Data 2 from source 1 represents values of a second parameter (e.g. outside temperature) associated with the first cold storage unit at the first time interval (t1). Similarly, data 3 from source 1 represents values of a third parameter (e.g., energy consumption) associated with the first cold storage unit at the first time interval (t1). Similarly, the values of the second parameter and the third parameter are obtained at various periodic intervals of time (e.g., t2, t3, and t4). Likewise, data 1, data 2, and data 3 from source 2 and source 3 are obtained. In one embodiment, only values associated with parameters are obtained by the one or more hardware collection units 102. However, processing of data or contextualization of data to identify i) a source associated with each value (i.e., a value of a parameter associated with a cold storage unit at a time interval) and ii) corresponding parameters (e.g., a value 201 corresponds to a parameter ‘X’) are not performed at the hardware collection units 102. In one embodiment, the raw data including values associated with the one or more parameters are time-stamped to indicate a time at which each value is measured and/or obtained. Such data are referred as time-stamped raw data.

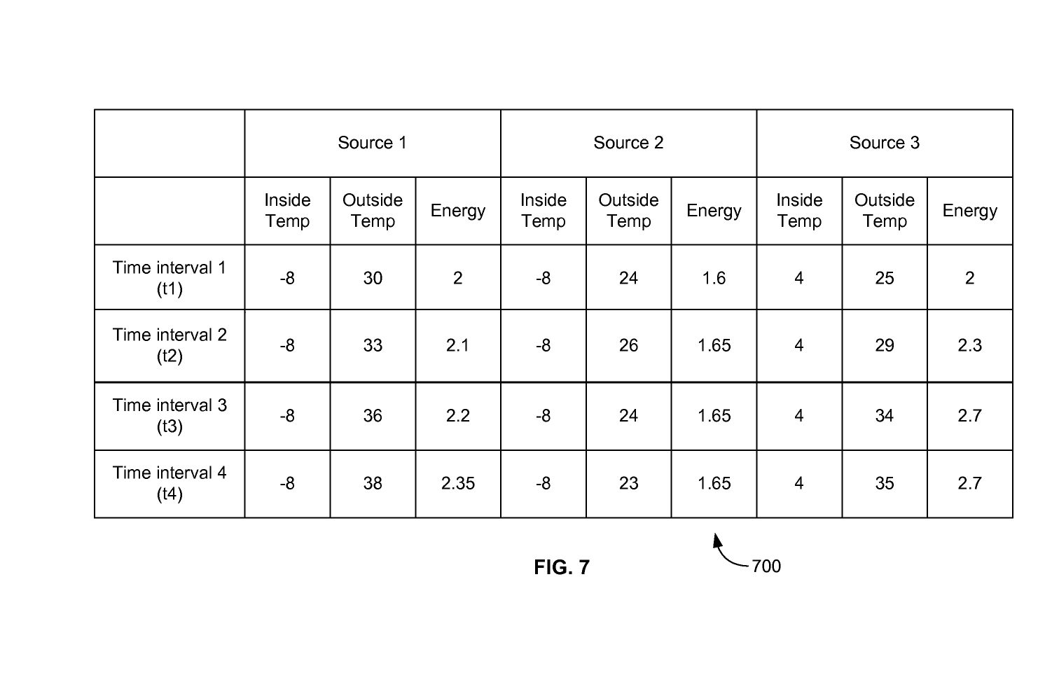

With reference to FIG. 6, FIG. 7 is a table view 700 illustrating sources and parameters correspond to values that are obtained using the one or more hardware collection units 102 of the system of FIG. 1 according to one embodiment of the present disclosure. The one or more hardware collection units 102 communicate time-stamped raw data to one or more centralized logging and monitoring platform (CLMP) 104. For example, the hardware collection units 102 communicate time-stamped raw data (shown in the FIG. 6) associated with various parameters of cold storage units collected at various periodic time intervals to a centralized logging and monitoring platform (CLMP) 104. The centralized logging and monitoring platform 104 calibrates each value and generates a calibrated data (shown in the FIG. 7). Further, the centralized logging and monitoring platform 104 processes and identifies (i) a source associated with each value and (ii) corresponding parameters (e.g., a value −8 corresponds to inside temperature of the first cold storage unit measured at the first time interval, a value 30 corresponds to outside temperature, and a value 2 corresponds to an energy consumption by the first cold storage unit). Similarly, a source and a parameter associated with each value are identified and contextualized.

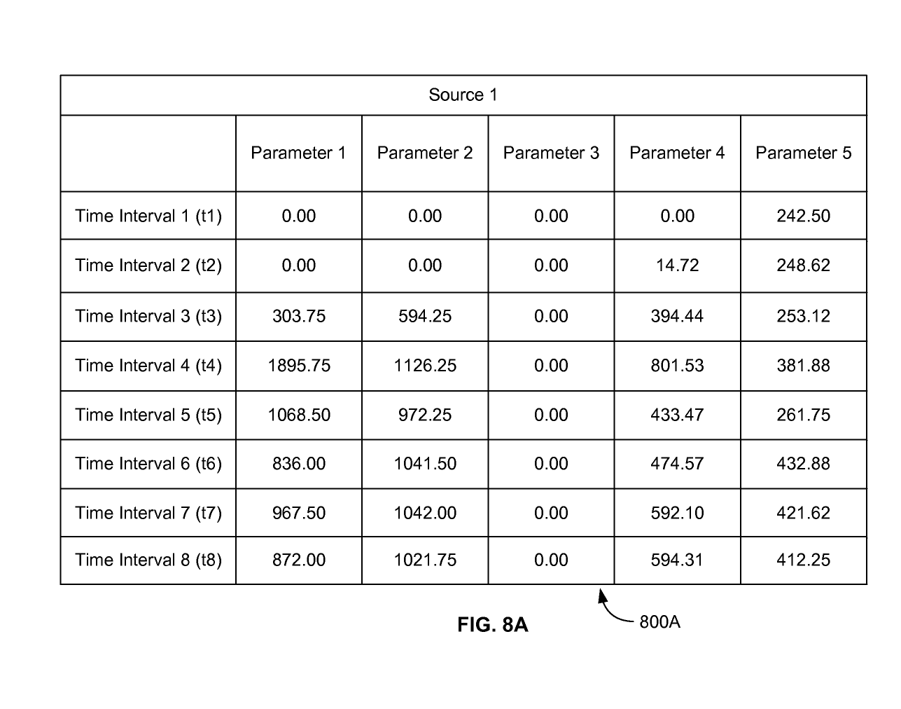

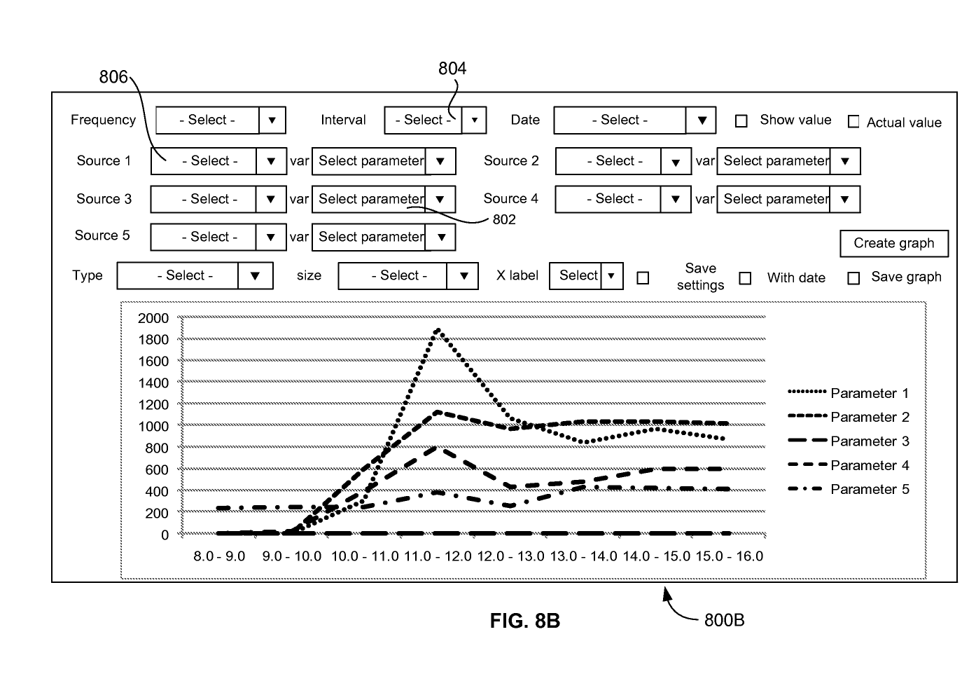

FIG. 8A is a table view 800A illustrating storing calibrated data in various time resolutions according to one embodiment of the present disclosure. The centralized logging and monitoring platform 104 stores calibrated data including each parameter and its corresponding value in various time resolutions (e.g., a second, a minute, a hour, a day, a month, etc.) at one or more storage units for easy, fast and fail-safe retrieval. The time resolutions indicate a duration at which each parameter is obtained and/or measured. For example, the table 800A indicates values of parameters (e.g., a parameter 1, a parameter 2, a parameter 3, a parameter 4, a parameter 5, etc.) associated with a source (e.g., a cold storage unit). In one example embodiment, the parameter 1, parameter 2, parameter 3, parameter 4, and a parameter 5 are corresponds to power consumption by AC1, AC2, AC3, AC4 and AC5 in Watts collected at various periodic time intervals. For example, as shown in FIG. 8A, a value 1068.50 corresponds to average power consumed by AC1 in Watts from 12.00 hour to 13.00 hour. The parameters and corresponding values collected at predefined periodic time intervals from one or more sources are stored in various time resolutions (e.g., a second, a minute, a hour, a day, a month, etc.) for easy, fast and fail-safe retrieval of data. The various resolutions of time allow the user to visualize the behavior of various parameters with respect to time and to conduct a analysis of the parameters. In addition, in one embodiment, the centralized logging and monitoring platform 104 may also store calibrated data in another format (e.g., a separate time based cubes for minute, hour, etc.) at a second storage unit.

FIG. 8B is a user interface view 800B illustrating providing inputs including a selection of one or more parameters and a time interval associated with an analysis and interpretation of the one or more parameters, and generating a graphical representation based on the inputs according to one embodiment of the present disclosure. The user interface view 800B may include, but not limited to, one or more parameters selection field 802, a duration selection field 804, and one or more source field 806, etc. For instance, when a user selects one or more parameters (e.g., a temperature, and a pressure) associated with a source 1 (e.g., a device, etc.) for a selected duration (e.g., a time interval), using the one or more parameters selection field 802, a graphical representation is generated that represents values associated with selected parameters for the selected duration. Selection of a duration from the duration selection field 804 for a source selected using the source field may generate a graphical representation that indicates values associated with industrial and/or infrastructure parameters that correspond to the selected source and the selected duration. Selection of a source using the source field 806 may generate a graphical representation that indicates values associated with one or more parameters of the selected source. Duration associated with an analysis and interpretation of parameters may be selected using the duration field 804. Similarly, with the calibrated data, various graphical representations are generated and provide analysis and interpretation of parameters with respect to time and/or duration based on a selection of input by a user.

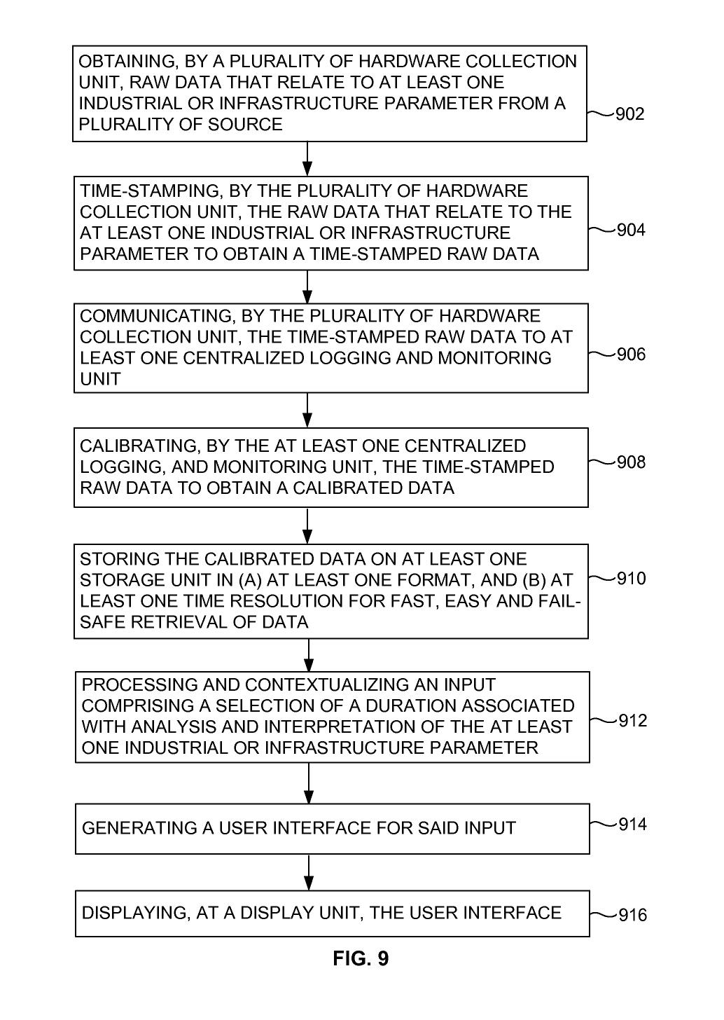

FIG. 9 is a flow diagram illustrating a method for collecting, calibrating, contextualizing, analyzing, interpreting and dispatching data that correspond to industrial and/or infrastructural parameters according to one embodiment of the present disclosure. In step 902, raw data that relate to one or more industrial and/or infrastructure parameters is obtained from one or more sources using one or more hardware collection units 102. In one embodiment, the one or more hardware collection units 102 may include one or more sensors, or one or more chips, or combinations thereof. The raw data includes values associated with each of the one or more industrial or infrastructure parameters collected at predefined periodic time intervals. In step 904, the raw data that relate to the one or more industrial and/or infrastructure parameters is time-stamped using the one or more hardware collection units 102 to obtain a time-stamped raw data. In step 906, the time-stamped raw data is communicated to one or more centralized logging and monitoring platform (CLMP) 104 using the one or more hardware collection units 102. In one embodiment, the centralized logging and monitoring platform (CLMP) 104 may be a computing device. In step 908, the time-stamped raw data is calibrated by the CLMP 104 to obtain a calibrated data based on the calibrated information provided by the user through the user interface. In step 910, the calibrated data is stored on one or more storage unit in at least one format, and at least one time resolution for easy, fast and fail-safe retrieval of data. In step 912, an input including a selection of at least one duration (e.g., time interval) associated with an analysis and interpretation of the one or more industrial and/or infrastructure parameter is processed and contextualized based on contextualization, analysis and interpretation information provided by the user. In step 914, a user interface is generated for the input. The user interface includes at least one of (a) status of the one or more industrial or infrastructure parameters, and (b) an analysis and interpretation of the one or more industrial or infrastructure parameters for the selected duration. In step 916, the user interface is displayed at a display system 106. In one embodiment, an interpretation of retrieved data is dispatched to the user (e.g., a person, or an ERP system, etc) using the user interface based on dispatching information provided by the user. The retrieved information is dispatched to the user via. a SMS, or an e-mail, in one example embodiment. The method may further include the following steps: (a) consolidating the calibrated data in at least one format (e.g., OS file system format, and/or data base storage format, etc.), and (b) storing the consolidated data in de-normalized form on one or more storage units for easy, fast and fail-safe retrieval of data. The method may further include the step of providing a user interface to configure/modify (a) calibration information required for calibrating the timestamped raw data, (b) contextualization information required for contextualizing the calibrated data, (c) analysis and interpretation information required for analysing and interpreting the calibrated data, and/or (d) dispatching information required for dispatching an interpretation to the user.

In another embodiment, a method for collecting raw data includes values that relate to one or more parameters from one or more sources using one or more hardware collection units 102 and contextualizing, analyzing and interpreting the values using at least one centralized logging and monitoring platform (CLMP) 104 is provided. The at least one CLMP 104 may include a computing device. The method includes the following steps: (i) obtaining, by the one or more hardware collection units 102, at least one value related to the one or more parameters from the one or more sources, the one or more parameters are at least one of (a) industrial parameters, and (b) infrastructure parameters; (ii) time-stamping, by the one or more hardware collection units 102, the at least one value to obtain a time-stamped value, the time-stamped value includes a time at which a value associated with the one or more parameters is measured; and (iii) communicating the time-stamped value to the at least one centralized logging and monitoring platform (CLMP) 104; (iv) calibrating, by the computing device, the time-stamped value to obtain calibrated data based on calibration information provided by the user; (v) storing the calibrated data on at least one storage unit in (i) at least one format, and (ii) at least one time resolution; (vi) processing, by a processor of the computing device, at least one input includes a selection of at least one of: (i) a desired parameter, (ii) a desired duration, and (iii) a desired duration associated with a desired parameter; (vii) generating, by the processor of the computing device, a graphical representation/interpretation based on the input, the graphical representation/interpretation includes at least one of (a) status of at least one of (i) the desired parameter, (ii) the desired duration, and (iii) the desired duration associated with the desired parameter, and/or (b) an analysis and interpretation of at least one of (i) the desired parameter, (ii) the desired duration, and (iii) the desired duration associated with the desired parameter; and (viii) displaying, at a display system 106, the user interface. In one embodiment, the retrieved information is dispatched to the user (e.g., a person, or an ERP system, etc) using the user interface. The retrieved information is dispatched to the user via. a SMS, or an e-mail, in one example embodiment.

In yet another embodiment, a method for analyzing data comprising values that relate to one or more parameters collected from one or more source using a centralized logging and monitoring platform (CLMP) 104 is provided. In one embodiment, the CLMP 104 includes a computing device. The method includes the following steps: (i) obtaining, by the computing device, at least one time-stamped value that relate to the one or more parameters collected at predefined periodic intervals, the one or more parameters are at least one of (a) industrial parameters, and (b) infrastructure parameters, the time-stamped value includes a time at which a value associated with the one or more parameters is measured; (ii) calibrating, by the computing device, the at least one time-stamped value to obtain calibrated data based on calibration information provided by the user; (iii) storing the calibrated data on at least one storage unit in (a) at least one format, and (b) at least one time resolution; (iv) processing, by a processor of the computing device, at least one input comprising a selection of at least one of: (a) a desired parameter, (b) a desired duration, and (c) a desired duration associated with a desired parameter; and (v) generating, by the processor of the computing device, a graphical representation/interpretation based on the input, wherein the graphical representation/interpretation comprises at least one of (a) status of at least one of (i) the desired parameter, (ii) the desired duration, and (iii) the desired duration associated with the desired parameter, and (b) an analysis and interpretation of at least one of (i) the desired parameter, (ii) the desired duration, and (iii) the desired duration associated with the desired parameter.

The system of FIG. 1 can incorporate a “soft automation” feature as a plug-in to plant or industrial infrastructure. The soft automation feature does not take a controlling decision instead it monitors and stores key performance data and alerts/informs/recommends an action to the user about an action that is needed. The system then logs the user action to the alerts/informs/recommends. ‘Soft Automation’ helps in achieving greater quality, and process efficiency. At a macroeconomic scale, the system 100 enables people with information and helps them consume resources in a socially responsible fashion.

In one embodiment, the CLMP 104 collects data from multiple unrelated sources that are distributed geographically and build relationship between them based on time.

The system of FIG. 1 is used across many industrial environments to monitor the key parameters effectively. The system gives a following advantages (i) improves Return On Investment (ROI) on capital goods by monitoring a productivity through multiple prospective, (ii) diagnoses faults efficiently, (iii) monitors quality of equipment/product in the industrial environment, (iv) reduces costly production downtime, (v) ease of effective inventory management, (vi) identifies inefficient energy consumption, (vii) gives information about where spare capacity is available, and (viii) helps consume resources in a socially responsible manner.

The cost effective system 100 to collect, calibrate, contextualize, analyse and interpret plant & infrastructure monitoring information includes the Hardware Collection Unit (HCU) 102, the Centralized Logging and Monitoring Platform (CLMP) 104 and the display system 106. The HCU 102 raw data from the different sensors (e.g., one or more sensors) and timestamps the raw data to obtain time-stamped raw data. The time-stamped raw data is transferred to the CLMP 104 via multiple communication networks. The CLMP 104 receives the time-stamped raw data from the HCU 102 and performs a calibration operation on the time-stamped raw data to obtain a calibrated data. The calibration operation is performed based on calibration information provided by the user. The calibrated data is consolidated and de-normalized and stored in at least on time resolution for easy, fast and fail-safe retrieval. The display system 106 provides a user interface to contextualize and analyze the calibrated data. The HCU 102 does not store, process, calibrate, or contextualize the time-stamped raw data that is collected from the different sensors, and thus reduces power consumption, minimizes management complexity and eliminates a memory/storage requirement such as non-volatile storage memory and RAM. Eliminating calibration and contextualization complexity from the HCU 102 and moving it to the CLMP 104 reduces the cost at the HCU 102. The schema of data handling at the CLMP 104 can be used for reliable storage and easy, fast and fail-safe retrieval using low cost PC hardware instead of complex automation hardware or server grade computers, thus to reducing cost at the CLMP 104.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A system for collecting and analyzing monitoring information of at least one industrial or infrastructure parameter, said system comprising:
a plurality of hardware collection units that are configured to collect raw data related to said at least one industrial or infrastructure parameter from a plurality of sources, wherein said plurality of hardware collection units timestamp said collected raw data, wherein said raw data comprises values associated with said at least one industrial or infrastructure parameter collected at predefined periodic time intervals;
a plurality of centralized logging and monitoring units that are configured to receive said timestamped raw data from said plurality of hardware collection units through a communication network, wherein said plurality of centralized logging and monitoring units calibrate and consolidate said timestamped raw data to obtain a calibrated data and store said calibrated data in at least one format; and
a display unit that is configured to display a user interface to contextualize and analyze said calibrated data.

2. The system of claim 1, wherein said plurality of centralized logging and monitoring units comprising:
a data collection engine that is configured to store said calibrated data in at least one storage unit in (a) said at least one format, and (b) at least one time resolution for retrieval of data;
a user interface engine that is configured to store at least one application program for providing said user interface;
a data contextualization engine that is configured to contextualize said calibrated data related to said at least one industrial or infrastructure parameter at the time of data retrieval based on a user input; and
a data analysis and interpretation engine that is configured to analysis and interpret said at least one industrial or infrastructure parameter corresponding to said user input received through said user interface.

3. The system of claim 1, wherein said plurality of hardware collection units comprise at least one sensor, or at least one chip, or combinations thereof.

4. The system of claim 1, wherein said display unit comprises a user interface to configure calibration information required for calibrating said time-stamped raw data.

5. The system of claim 1, wherein said display unit comprises a user interface to configure analysis and interpretation information required for analysing and interpreting said calibrated data.

6. The system of claim 1, wherein said display unit comprises a user interface to configure contextualization information required for contextualizing said calibrated data.

7. The system of claim 1, wherein said display unit comprises a user interface to configure dispatching information required for dispatching an interpretation.

8. The system of claim 2, wherein said data analysis and interpretation engine comprises a forward option and a backward option to access a next or previous time window, and a slider option to access said at least one time resolution.

9. A method for collecting raw data comprising values that relate to a plurality of parameters from a plurality of sources using at least one hardware collection unit and analyzing and interpreting said values using at least one centralized logging and monitoring platform (CLMP), wherein said at least one CLMP comprises a computing device, said method comprising:
(i) obtaining, by said at least one hardware collection unit, at least one value related to said plurality of parameters from said plurality of sources, wherein said plurality of parameters are at least one of (a) industrial parameters, and (b) infrastructure parameters;
(ii) time-stamping, by said at least one hardware collection unit, said at least one value to obtain time-stamped value, wherein said time-stamped value comprise a time at which a value associated with said plurality of parameters is measured; and
(iii) communicating said time-stamped value to said at least one centralized logging and monitoring platform (CLMP);
(iv) calibrating, by said computing device, said time-stamped value to obtain calibrated data;
(v) storing said calibrated data on at least one storage unit in (a) at least one format, and (b) at least one time resolution;
(vi) contextualizing, by a processor of said computing device, said calibrated data based on at least one input comprising a selection of at least one of:
(i) a desired parameter,
(ii) a desired duration, and
(iii) a desired duration associated with a desired parameter;
(vii) generating, by said processor of said computing device, an interpretation based on said input, wherein said interpretation comprises at least one of (a) status of at least one of (i) said desired parameter, (ii) said desired duration, and (iii) said desired duration associated with said desired parameter, and (b) an analysis of at least one of (i) said desired parameter, (ii) said desired duration, and (iii) said desired duration associated with said desired parameter; and
(viii) displaying, at a display unit, said user interface.

10. The method of claim 9, further comprising:
consolidating and de-normalizing said calibrated data for easy, fast and fail-safe retrieval of data; and
storing said consolidated and de-normalized data form in said at least format on at least one storage unit.

11. The method of claim 9, further comprising providing a user interface to configure calibration information required for calibrating said time-stamped raw data.

12. The method of claim 9, wherein said plurality of hardware collection units comprise at least one sensor, or at least one chip, or combinations thereof.

13. A method for analyzing data comprising values that relate to a plurality of parameters collected from a plurality of sources using a centralized logging and monitoring platform (CLMP), wherein said CLMP comprises a computing device, said method comprising:
(i) obtaining, by said computing device, at least one time-stamped value that relate to said plurality of parameters collected at predefined periodic intervals, wherein said plurality of parameters are at least one of (a) industrial parameters, and (b) infrastructure parameters, wherein said time-stamped value comprise a time at which a value associated with said plurality of parameters is measured;
(ii) calibrating, by said computing device, said at least one time-stamped value to obtain calibrated data;
(iii) storing said calibrated data on at least one storage unit in (a) at least one format, and (b) at least one time resolution;
(iv) contextualizing, by a processor of said computing device, said calibrated data based on at least one input comprising a selection of at least one of:
(a) a desired parameter,
(b) a desired duration, and
(c) a desired duration associated with a desired parameter; and
(v) generating, by said processor of said computing device, an interpretation based on said input, wherein said interpretation comprises at least one of (a) status of at least one of (i) said desired parameter, (ii) said desired duration, and (iii) said desired duration associated with said desired parameter, and (b) an analysis of at least one of (i) said desired parameter, (ii) said desired duration, and (iii) said desired duration associated with said desired parameter.

14. The method of claim 13, further comprising:
consolidating and de-normalizing said calibrated data for easy, fast and fail-safe retrieval of data; and
storing said consolidated and de-normalized data form in said at least format on at least one storage unit.

15. The method of claim 13, wherein said at least one time-stamped value is obtained using a plurality of hardware collection units.

16. The method of claim 15, wherein said plurality of hardware collection units comprise at least one sensor, or at least one chip, or combinations thereof.

17. The method of claim 13, further comprising providing a user interface to configure calibration information required for calibrating said timestamped raw data.

18. The method of claim 13, further comprising providing a user interface to configure analysis and interpretation information required for analysing and interpreting said calibrated data.

19. The method of claim 13, further comprising providing a user interface to configure contextualization information required for contextualizing said calibrated data.

20. The method of claim 13, further comprising providing a user interface to configure dispatching information required for dispatching an interpretation.
